(19) United States
(12) Patent Application Publication
(10) Pub. No.: US 2019/0383628 A1
(43) Pub. Date: Dec. 19, 2019

(54) TRIP PLANNING METHOD AND ASSEMBLY

(71) Applicant: Ford Global Technologies, LLC, Dearborn, MI (US)

(72) Inventors: Jason Quint, Ann Arbor, MI (US); Paul Aldighieri, Grosse Pointe Farms, MI (US); Josef Hackl, Detroit, MI (US); Ryan Hunt, Ferndale, MI (US); Nicholas Tetlow, Plymouth, MI (US); Dale Gilman, Beverly Hills, MI (US)

(21) Appl. No.: 16/009,565

(22) Filed: Jun. 15, 2018

(51) Int. Cl. G01C 21/34; G06N 5/04; G01C 21/36

(52) U.S. Cl. CPC G01C 21/3469; G06N 5/04; G01C 21/3626; G01C 21/3492; G01C 21/3484

(57) ABSTRACT

An exemplary trip planning method includes, among other things, recommending at least one stop for a vehicle. Under first conditions, the recommending is based on a vehicle need and a user need. Under second conditions, the recommending is based on the vehicle need and an environmental factor. An exemplary trip planning assembly includes, among other things, a controller module that recommends at least one stop for a vehicle. Under first conditions, the at least one stop is recommended based on a vehicle need and a user need. Under second conditions, the at least one stop is recommended based on the vehicle need and an environmental factor.

### TECHNICAL FIELD

This disclosure relates generally to planning a trip to a destination and, more particularly, to providing a user of a vehicle with one or more recommended stops along a route to the destination.

### BACKGROUND

Electrified vehicles differ from conventional motor vehicles because electrified vehicles are selectively driven using one or more electric machines powered by a traction battery. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

Many conventional and electrified vehicles can include a navigation package that assists a user when planning a route for the vehicle from a start point to a destination. Prior to reaching the destination, a user may stop the vehicle one or more times. Stops could be necessary due to a vehicle need, such as a need to recharge a traction battery of an electrified vehicle. Stops could be necessary due to a user need, such as a need for the user to eat, visit a restroom, etc. Typically, a user manually investigates potential stops along the route to the destination. The manual investigation is needed to determine, for example, which stops provide the least expensive charge options, which stops provide the fastest charge times, which stops offer food, etc.

### SUMMARY

A trip planning method according to an exemplary aspect of the present disclosure includes, among other things, recommending at least one stop for a vehicle. Under first conditions, the recommending is based on a vehicle need and a user need. Under second conditions, the recommending is based on the vehicle need and an environmental factor.

In a further non-limiting embodiment of the foregoing method, the recommending occurs prior to departing on a drive to a destination.

In a further non-limiting embodiment of any of the foregoing methods, the vehicle need is a charge of a traction battery, and the at least one stop includes a plurality of charging stops presented to a user of the vehicle.

In a further non-limiting embodiment of any of the foregoing methods, the plurality of charging stops includes a charging stop designated as the least expensive charging stop and a charging stop designated as the fastest charging stop. The fastest charging stop can mean the charging stop having the smallest time impact to a journey to the destination.

In a further non-limiting embodiment of any of the foregoing methods, the recommending includes recommending a stop based on the stop having a 110 Volt power outlet.

In a further non-limiting embodiment of any of the foregoing methods, the vehicle need is a charge of a traction battery and the at least one stop is at least one charging stop. The method further includes providing an alert to a user based on a distance to the at least one charging stop and a distance to empty for the vehicle.

A further non-limiting embodiment of any of the foregoing methods includes varying the alert based on the distance to the at least one charging stop and the distance to empty for the vehicle.

In a further non-limiting embodiment of any of the foregoing methods, the alert is a text based message.

In a further non-limiting embodiment of any of the foregoing methods, the recommending is after the providing of the alert.

A further non-limiting embodiment of any of the foregoing methods includes receiving a selected charging stop selected by the user, and updating a route for the vehicle based on the selected charging stop.

In a further non-limiting embodiment of any of the foregoing methods, the user need, the vehicle need, and the environmental factor are each categorized as low urgency or high urgency.

In a further non-limiting embodiment of any of the foregoing methods, the recommending prioritizes a high urgency vehicle need above both low and high urgency user needs.

In a further non-limiting embodiment of any of the foregoing methods, the environmental factor includes at least one of a traffic condition or a weather condition.

A trip planning assembly according to another exemplary aspect of the present disclosure includes, among other things, a controller module that recommends at least one stop for a vehicle. Under first conditions, the at least one stop is recommended based on a vehicle need and a user need. Under second conditions, the at least one stop is recommended based on the vehicle need and an environmental factor.

In another non-limiting embodiment of the foregoing assembly, the vehicle includes the controller module.

Another non-limiting embodiment of any of the foregoing assemblies includes a traction battery of the vehicle. The vehicle need is a charge of the traction battery.

In another non-limiting embodiment of the foregoing assembly, the at least one stop includes a plurality of charging stops presented to a user of the vehicle.

Another non-limiting embodiment of the foregoing assembly includes a display within the vehicle. The plurality of charging stops are presented to the user on the display.

In another non-limiting embodiment of the foregoing assembly, the vehicle need is a charge of a traction battery and the at least one stop is at least one charging stop. The controller module provides an alert to a user based on a distance to the at least one charging stop and a distance to empty for the vehicle.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle.

FIG. 2 illustrates a highly schematic view of selected portions of the electrified vehicle of FIG. 1.

FIG. 3 illustrates a trip planning method according to an exemplary aspect of the present disclosure.

FIG. 4 illustrates a trip planning method according to another exemplary aspect of the present disclosure.

FIGS. 5A-5B illustrates a trip planning method according to yet another exemplary aspect of the present disclosure.

FIGS. 6A-6B illustrates a trip planning method according to yet another exemplary aspect of the present disclosure.

FIGS. 7A-7B illustrates a trip planning method according to yet another exemplary aspect of the present disclosure.

FIG. 8 illustrates a trip planning method according to yet another exemplary aspect of the present disclosure.

FIGS. 9A-9C illustrates a trip planning method according to yet another exemplary aspect of the present disclosure.

### DETAILED DESCRIPTION

This disclosure relates generally to planning a trip to a destination in a vehicle. The planning can include providing a user of the vehicle with recommended stops along a route to the destination. The recommendations can be based on vehicle needs, user needs, environmental factors, or some combination of these. The recommended stops can be provided prior to beginning the trip, or during the trip.

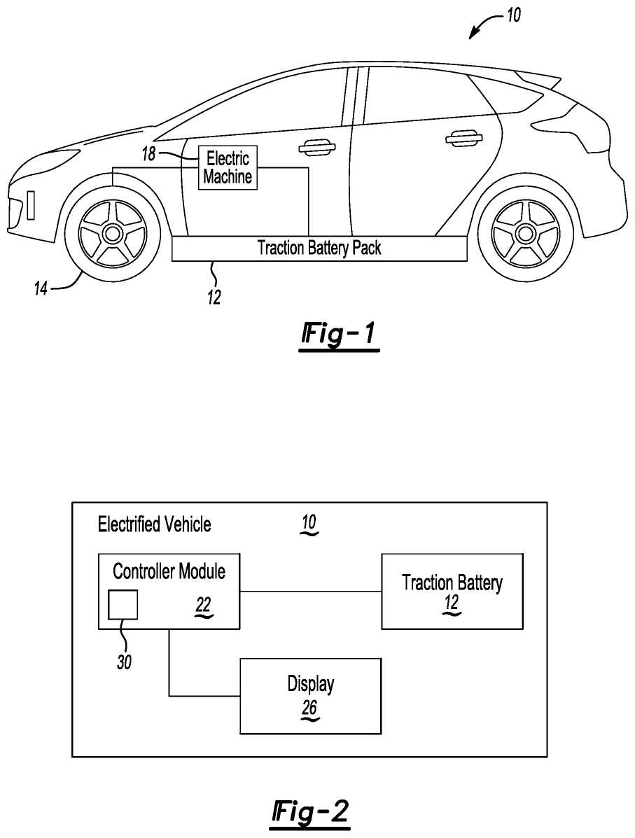

Referring to FIG. 1, an exemplary electrified vehicle 10 includes a traction battery 12. The electrified vehicle 10 can be used to transport a user on a trip along a route to a destination. The user can be a driver or a passenger within a passenger compartment of the electrified vehicle.

A power-split powertrain of the electrified vehicle 10 employs a first drive system and a second drive system. The first and second drive systems can generate torque to drive one or more sets of vehicle wheels 14.

The first drive system can include, in combination, an internal combustion engine and a generator. The second drive system can include at least a motor, the generator, and the traction battery 12. The motor and the generator are types of electric machines 18. The motor and generator can be separate, or can have the form of a combined motor-generator.

The exemplary electrified vehicle 10 is described above as an all-electric vehicle. The electrified vehicle 10, in other examples, could be another type of electrified vehicle, such as a hybrid electric vehicle (HEV).

The teachings of this disclosure could apply to electrified vehicles of the types described above as well as to conventional vehicles. That is, the teachings of this disclosure could apply to many types of vehicles used to transport a user along a route to a destination.

With reference now to FIG. 2, the electrified vehicle 10 includes a controller module 22 and a display 26. The controller module 22 is operably coupled to the traction battery 12. The controller module 22 can monitor a state of charge of the traction battery 12.

The display 26 can be a display within a passenger compartment of the electrified vehicle 10. The display 26 is operably coupled to the controller module 22. The controller module 22 can provide an output causing information to be displayed on the display 26, which can be viewed by the user of the electrified vehicle 10.

The controller module 22 can be a stand-alone controller, or incorporated into a controller module, such as a battery electronic control module (BECM). The controller module 22 could include multiple separate controller modules in the form of multiple hardware devices, or multiple software controllers within one or more hardware devices. At least some portions of the controller module 22 could, in some examples, be located remote from the electrified vehicle 10, such as when portions of the controller module 22 are cloud-based. The controller module 22 can include, among other things, a processor and a memory portion.

The processor of the controller module 22 can be programmed to execute a program stored in the memory portion. The processor can be a custom made or commercially available processor, a central processing unit (CPU), an auxiliary processor among several processors associated with the controller module, a semi-conductor based microprocessor (in the form of a microchip or chipset) or generally any device for executing software instructions. The memory portion can include any one or combination of volatile memory elements. The program can be stored in such the memory portion as software code. The programs can include one or more additional or separate programs, each of which includes an ordered list of executable instructions for implementing logical functions associated with the electrified vehicle 10.

The example controller module 22 additionally includes a receiver 30 that can receive information from a location remote from the electrified vehicle 10. The information received by the receiver portion can include information about environmental factors.

The environmental factor information can be transmitted to the controller module 22 through the receiver 30 using a satellite, for example. Weather information, upcoming traffic conditions along the route (e.g., traffic building ahead), nightfall is approaching, a time of day is approaching a mealtime, and road hazards along the route are all examples of the types of environmental factors that could be sent to the controller module 22 via the receiver 30.

In some examples, the controller module 22 could additionally include a transmitter operative to request environmental factor information, or other information, from outside the electrified vehicle 10.

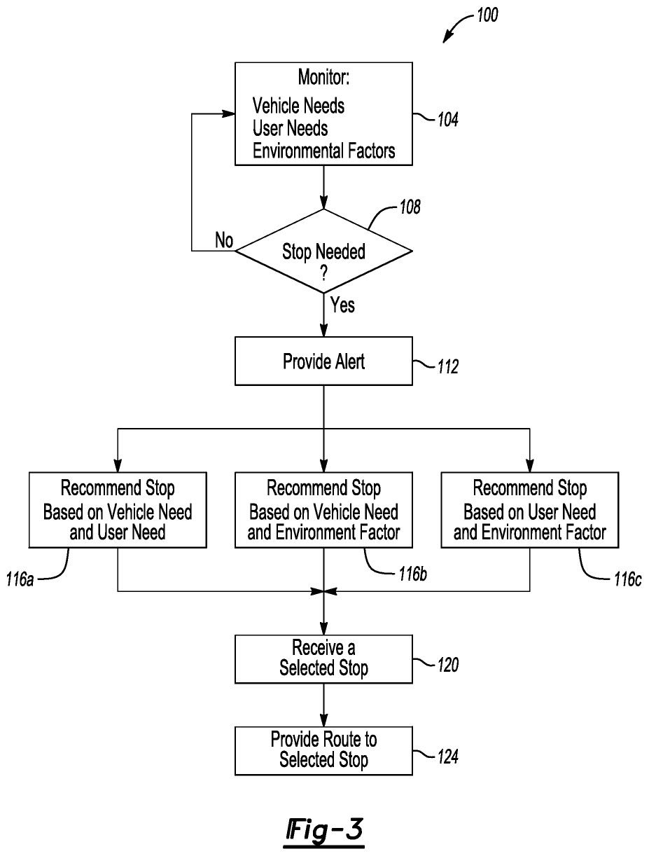

Referring now to FIG. 3 with continuing reference to FIG. 2, an example trip planning method 100 can assist a user of the electrified vehicle 10 during a drive along a route to a destination, or prior to beginning the drive. At least some steps of the method 100 can be executed by the controller module 22

The method 100 begins at a step 104 where the controller module 22 monitors vehicle needs, user needs, and environmental factors. Exemplary vehicle needs can include the traction battery 12 having a state of charge that drops below a threshold level. Another exemplary vehicle need could include, when the electrified vehicle 10 is a conventional vehicle, a urea tank having a fluid level dropping below a threshold level. Yet another exemplary vehicle need could include a pressure of one of the wheels of the electrified vehicle 10 falling below a threshold level.

User needs are different than the vehicle needs. User needs are associated with the user of the electrified vehicle 10 rather than the electrified vehicle 10 itself. Exemplary user needs could include a user of the electrified vehicle 10 needing to stop for food, or to download a file shared to the user by a coworker. Other example user needs could include a required restroom break, or a stop for coffee.

The controller module 22 could monitor for inputs from the user indicating a user need. The user could, for example, input a user need through the display 26. In another example, the user could communicate a user need to the controller module 22 via a spoken command. The controller module 22 could detect other user needs automatically, such as a suggested rest break or coffee break due to a detected driving style. For example, erratic driving of the electrified vehicle 10 could be interpreted as a user of the vehicle requiring rest, which is a type of user need.

Environmental factors, as previously described, relate to factors outside the vehicle. The environmental factors are separate from the user needs and the vehicle needs. The environmental factors can be received by the receiver 30.

The controller module 22 can, in some examples, categorize or classify the user needs as low or high urgency user needs, the vehicle needs as low or high urgency vehicle needs, the environmental factors as low or high urgency factors, or some combination of these. High urgency user and vehicle needs, and high urgency factors can then be prioritized above low urgency user and vehicle needs, and low urgency factors.

Low urgency user needs could be a hungry user, or a need to download a file. High urgency user needs could be a restroom break or a need for coffee to enhance an alertness of the user. Low urgency vehicle needs could be a charge of the traction battery 12 being required to reach the destination, or a UREA tank refill. High urgency vehicle needs could be a low state of charge for the traction battery 12, say five percent, or a low pressure detected in a vehicle tire, say a pressure that is fifty percent of a specified pressure. A low urgency environmental factor could be a cold front detected that is upcoming along the route, or a time of day approaching nightfall. A high urgency environmental factor could be a severe traffic jam, or a road closure along the route due to a traffic accident.

The controller module 22 continually monitors the vehicle needs, user needs, and environmental factors in the step 104. At a step 108, the method 100 assesses whether or not a stop is needed based on the vehicle needs, user needs, and environmental factors monitored in the step 104. A stop refers to a stop of the electrified vehicle 10 prior to reaching the destination.

In a particular embodiment, a high urgency vehicle need, such as a required recharge, is prioritized above both low and high urgency user needs. The controller module 22 thus recommends a stop based on the high urgency vehicle need first, and then based on the low or high urgency user need.

If no stop is required, the method 100 continues to monitor the step 104. If a stop is required, the controller module 22 can provide an alert at a step 112. The alert could be an alert provided to the user on the display 26, an audible alert, or some other type of alert provided to the user.

At a step 116a, the method 100 recommends at least one stop for the electrified vehicle 10 based on both a vehicle need and a user need. The method 100 could instead, at a step 116b, recommend at least one stop based on a vehicle need and an environmental factor. The method 100 could instead, at a step 116c, recommend at least one stop based on a user need and an environmental factor. In some examples, the recommending of the stops at the steps 116a, 116b, or 166c provides the alert schematically represented in step 112. That is, the step 112 could be combined with the step 116a, 116b, or 116c.

With reference to the step 116a, the recommended at least one stop could be provided based on the user need being a need for food, which could be obtained at the stop, and a vehicle need of the traction battery 12 requiring a recharge. The step 116a provides the user with at least one recommended stop. Each of these provided recommended stops has both charging capability and provides food. Accordingly, the user would not need to stop the electrified vehicle 10 at a first location along the route to obtain food, and then, after driving some more along the route, stop the electrified vehicle 10 again to charge the electrified vehicle 10. In some examples, the recommended stops are recommended based on a power available at the recommended stops (e.g., L1, L2, L3).

At the step 116b, the at least one recommended stop could be recommended based on a required recharge of the traction battery 12 and an upcoming traffic jam. In such an example, the step 116b includes calculations confirming that, for the electrified vehicle 10 to reach a destination, the traction battery 12 requires a recharge. Also, in this example, an environmental factor indicates that the electrified vehicle 10 will enter a traffic jam situation if the electrified vehicle 10 continues to drive for another ten minutes along the route.

Rather than have the electrified vehicle 10 continue along the route to the traffic jam, the step 116b provides the user with a list of recommended stops that enable the user to charge the traction battery 12 prior to the electrified vehicle 10 reaching the traffic jam. Accordingly, the user can spend time charging the traction battery 12, which may permit the traffic jam to clear.

If the user instead continued to their destination, the user would enter the traffic jam situation, but still ultimately be required to charge the traction battery 12. This could delay the user on the way to their destination more than stopping to charge the traction battery 12 prior to reaching the traffic jam.

At a step 120, the method 100 receives a selected stop. The selected stop could be selected from the recommended stops provided at the step 116a or 116b. The selected stop 120 could be inputted by the user via the display 26.

In response to the selected stop, a step 120 provides a route to the selected stop at a step 124. The user can then direct the vehicle along the route to the selected stop.

The example method 100 could be executed as the electrified vehicle 10 is driving along a route toward a destination. Alternatively, the method 100 could be executed prior to the electrified vehicle 10 beginning its travel to the destination. For example, the user could input a destination to the controller module 22 without the electrified vehicle 10 beginning a drive cycle. In some examples, the user can input a destination via a mobile device and have the destination sent to the electrified vehicle 10 even when the user is not in a passenger compartment of the electrified vehicle 10. The trip planning method 100 could then be executed in response to the destination to provide, if required, recommended stops to the user along the route to the destination.

In some examples, the method 100 could include a recommendation for the user to adjust the electrified vehicle to a particular driving mode (e.g., EV-Now, EV-Later, etc.)

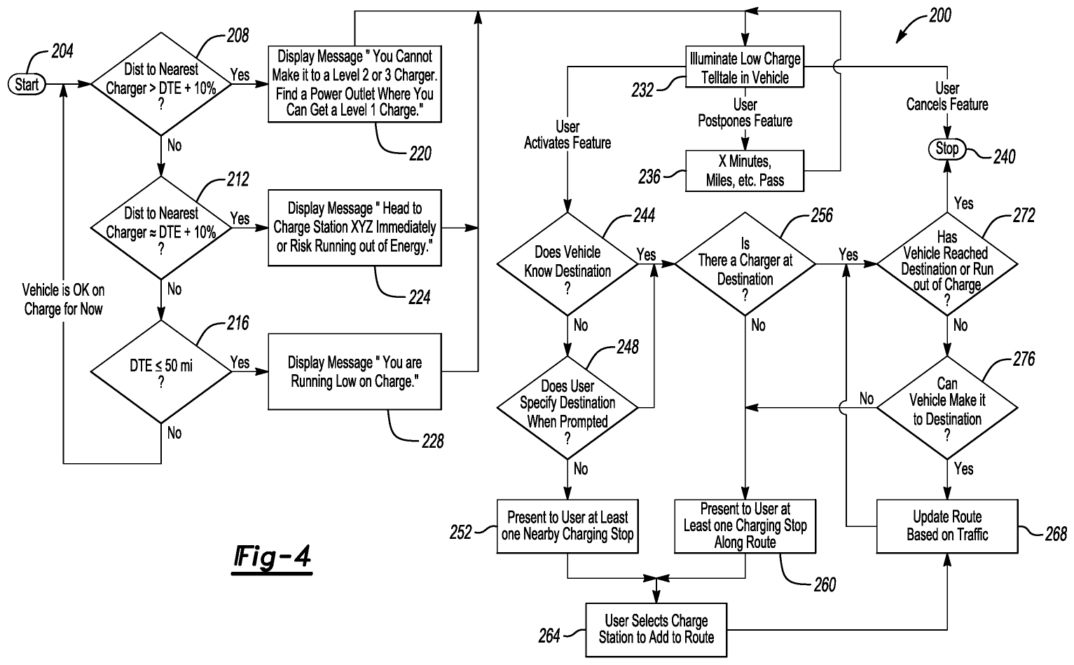

With reference now to FIG. 4 and continuing reference to FIG. 2, another example trip planning method 200 can assist a user of the electrified vehicle 10 during a drive along a route to a destination, or prior to beginning the drive. At least some steps of the method 200 can be executed by the controller module 22.

The method 200 begins at a start 204. Next, at steps 208, 212, and 216, a distance to a nearest charging station is compared to a distance to empty for the electrified vehicle 10, plus a safety factor. In this example, the safety factor is 10%. Other safety factors could be used in other examples.

If a distance to the nearest charging station is greater than a distance to empty plus the safety factor, the method 200, at the step 208, displays a message type 220. If the distance to the nearest charger is equal to the distance to empty plus the safety factor at the step 212, the method 200 moves to a step 224 which displays another message type. If the distance to empty is less than or equal to, for example, fifty miles at a step 216, the method 200 displays a third message type 228. Different exemplary message types are shown in FIG. 4, but this disclosure is not limited to those exact message types. If the distance to empty is greater than fifty miles, the example method 200 returns to the step 208.

As described in connection with the steps 220, 224, and 228 of the exemplary method 200, the method 200 varies a message type or alert based on a distance to at least one charging stop and a distance to empty for the electrified vehicle 10. The messages displayed in the steps 220, 224, 228 are different text-based, low-charge alert messages. In other examples, other types of messages could be displayed.

After displaying the messages in the steps 220, 224, 228, the method 200 provides an alert at a step 232. The alert, in this example, is a low charge light illuminated within a passenger compartment of the electrified vehicle 10. The illuminated low charge light notifies the user of the electrified vehicle 10 of the low charge state.

The user can, at a step 236, optionally pause the low charge alert for X number of minutes, miles, etc. The customer could also, at the step 236, cancel the low charge alert such that the method 200 moves from the step 232 directly to a stop step 240.

If the customer does not postpone or cancel the alert at the step 236, the method 200 moves to a step 244, which determines whether a destination for the electrified vehicle 10 is known. If the destination is not known, the method 200 moves to a step 248, which prompts the user to specify a destination.

If the user does not specify a destination at the step 248, the method 200 presents to the user a list of at least one nearby charging stop at a step 252. The at least one nearby charging stop can include a plurality of nearby charging stops, which are designated as the least expensive, the fastest charging stop, the type of charging stop. The fastest charging stop can mean the charging stop having the smallest time impact to a journey to the destination. The at least one nearby charging stop is considered a SMART recommendation as the at least one charging stop can be recommended based on a combination of customer/vehicle needs and environmental conditions. The nearby charging stops at the step 252 can be those that are nearby the electrified vehicle 10, say within ten miles of the electrified vehicle 10, as the user has not specified a destination for the electrified vehicle 10.

If at the step 244, the destination is known, or if the destination is known in response to the prompting of the user at the step 248, the method 200 moves to a step 256, which assesses whether or not there is a charger at the destination. Such information about the destination could be obtained from a database and, for example, transmitted to the electrified vehicle 10 through the receiver 30.

If not, the method 200 moves the step 260, which presents to the user a plurality of charging stations along a route to the destination. Some of the charging stations presented in the step 260 can be designated as the least expensive, the fastest charging stop, and by the type of charging stop (e.g., SMART). The plurality of charging stations in the step 260 correspond to the charging stations along the route to the destination.

After the steps 252 or 260, the user can select, at a step 264, a charging stop from those presented to the user in the steps 252 or 260. The method 200 then moves to a step 268, which updates a route for the electrified vehicle 10. The updated route can be based on, among other things, upcoming traffic conditions.

At the step 256, if there is a charger at the destination, the method 200 moves to a step 272, which determines whether the electrified vehicle 10 has reached the destination or run out of charge. If the electrified vehicle has reached the destination or run out of charge, the method 200 moves to the stop step 240. If the electrified vehicle 10 has not reached the destination or run out of charge, the method moves to a step 276, which assesses whether the electrified vehicle 10 can make it to the destination on the current level of charge. If not, the method 200 moves to the step 260. If the electrified vehicle 10 can make it to the destination of the step 276, the method 200 moves to the step 268, which again, can update the route based on, for example, upcoming traffic conditions. After, if required, updating the route at the step 268, the method 200 moves to the step 272.

In some examples, in the steps 252 and 260, there are no charging stations configured to directly charge the electrified vehicle 10. In such situations, the method 200 can recommend the charging stop as any location having a 110 volt power outlet. From the 110 Volt power outlet, the user can charge the electrified vehicle 10 with, for example, a level 1 charge. Any of the methods in this disclosure could optionally include a recommendation for a charge from a 110 Volt power outlet, when applicable.

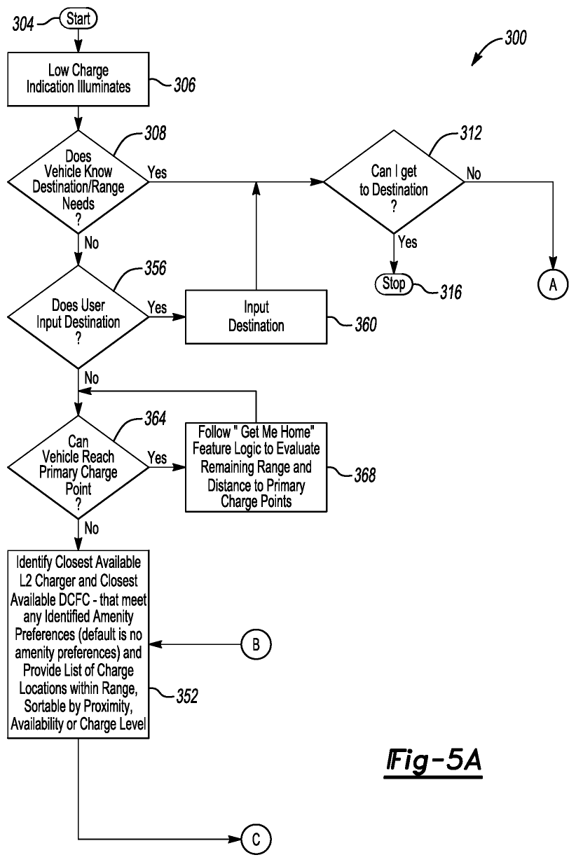

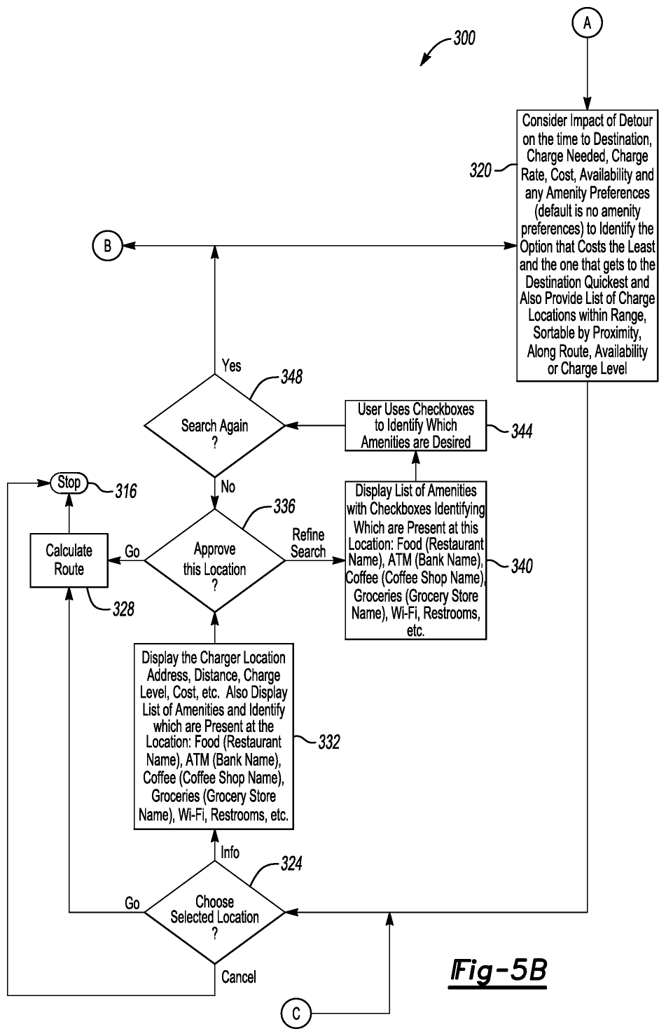

With reference now to FIGS. 5A-5B and continuing reference to FIG. 2, another example trip planning method 300 can assist a user of the electrified vehicle 10 during a drive along a route to a destination, or prior to beginning to travel along the route to the destination. At least some steps of the method 300 can be executed by the controller module 22.

The method 300 begins at a step 304. Next, at a step 306, a state of charge of a traction battery 12 dropping below a threshold amount causes a low charge indicator to illuminate. Next, at a step 308, the method 300 assesses whether or not a destination/range need for the electrified vehicle 10 is known. If yes, the method 300 moves to a step 312, which assesses whether or not the electrified vehicle 10 can reach the destination based on the amount of charge within the traction battery 12. If yes, the method 300 stops at a step 316.

If the electrified vehicle 10 cannot reach the destination at the step 312, the method 300 moves to a step 320 where the method 300 can, in consideration of the variables listed in step 320 for example, provide a list of at least one charging stop within range of the electrified vehicle 10. The charging stops can be sorted by proximity, availability, and the types of charges available.

After the step 320, the method 300 moves to a step 324, where a user can select a charge station from the listing of at least one charging stops. The method 300 can then move to a step 328, which calculates a route to the selected charging stop and presents the route to the user. The method 300 then moves from a step 328 to the stop step 316.

At the step 324, the user can also cancel the method 300 at the step 324 and move directly to the stop 316.

At the step 324, the user can also request additional information about the at least one charging stop from the step 320. The additional information can be displayed at a step 332. The additional information can include the location of the charging stops, distance to the charging stops, available charge levels at the charging stops, costs, etc. Amenities, such as food availability, restrooms, etc. that are associated with the charging stops can also be displayed at the step 332.

Next, at a step 336, the user can approve the charging stop having information displayed in the step 332. If approved, the method 300 moves from the step 336 to the step 328. If not approved, the method 300 can move to a step 340, which displays a list of amenities with, for example, checkboxes identifying which amenities are present at the at least one charging stop. At a step 344, the user can utilize the checkboxes or another input mechanism to identify which amenities are desired for the at least one charging stop. The method 300 then moves to a step 348 where the method 300 searches again for at least one stop based on the identified amenities from the step 344.

From the step 348, the method 300 can move back to the step 320, or move to a step 352, which identifies the closest available L2 charger and closest available DCFC charger that meet the amenity preferences identified by the user in the step 344. The user can be provided with a list of at least one charging stop within range of the electrified vehicle 10 sorted by proximity to vehicle 10 and their availability or charge levels at the step 352. From the step 352, the method 300 moves back to the step 324.

If at the step 308, the destination is unknown, the method moves to a step 356, which requests a destination from the user. If the user inputs the destination, the method moves to a step 360, and then to the step 312.

If the user elects not to specify the destination at the step 360, the method 300 moves from the step 356 to the step 364, which assesses whether or not the electrified vehicle 10 can make it to a primary charge point, which can be a charging station that the user frequently uses to charge the electrified vehicle 10, a charging station that the user has designated as a favorite, or both. The primary charge point could be located at the user's home or workplace, for example.

If the electrified vehicle 10 cannot make it to the primary charge point, the method 300 moves from the step 364 to the step 352. If the electrified vehicle 10 can make it to the primary charge point, the method 300 moves from the step 364 to the step 368, which utilizes Get Me Home feature logic, or similar logic, to evaluate a remaining range of the electrified vehicle 10 and a distance to the primary charge point. The Get Me Home feature logic can inform the user that the electrified vehicle 10 has X miles of remaining range and can make it home without running out of energy. From the step 368, the method 300 moves back to the step 364.

In an example of the method 300, a low state of charge of the traction battery 12 could trigger the method 300 to provide a recommended stop. The recommended stop could account for a time required to drive to the destination, an amount of charge required to reach the destination, a rate of charge provided by potential charging stops, a cost of the charge at potential charging stops, an availability of charging at potential charging stop. The method 300 then provides the user with one or more recommended stops that offer the least expensive and fastest charge capabilities. The recommended stops could be further refined by the user needs, such as a desire for food, restroom break, Wi-Fi hotspot etc.

If, for example, a state of charge of the traction battery 12 is at five percent, the destination is 100 miles away, and the user desires coffee, the method 300 could recommend that the user stop the electrified vehicle 10 for thirty minutes at a nearby coffee shop having a charging station. In such an example, the low state of charge is the primary need or trigger, and the need for coffee is a secondary need that refines the grouping of stops meeting the primary need.

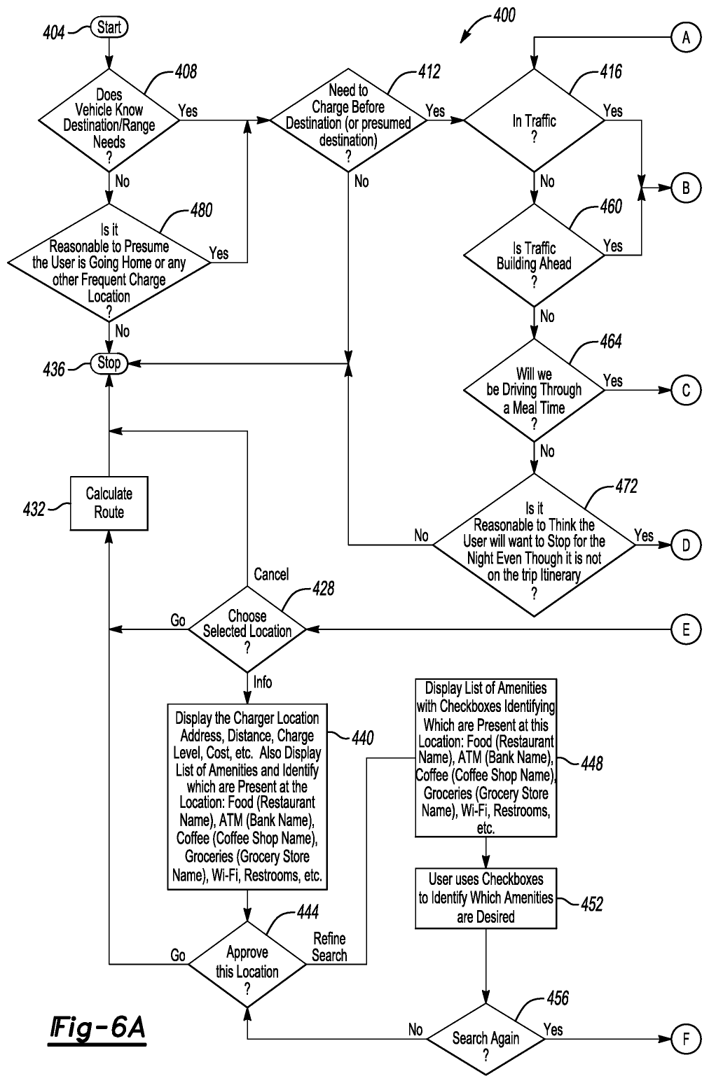

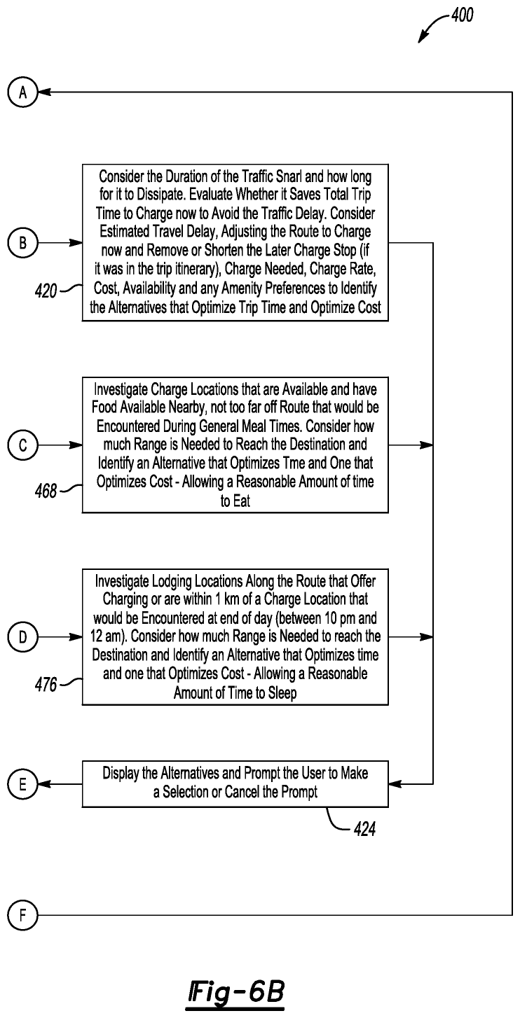

With reference now to FIGS. 6A-6B and continuing reference to FIG. 2, another example trip planning method 400 can assist a user of the electrified vehicle 10 during a drive along a route to a destination, or prior to beginning to travel along the route to the destination. At least some steps of the method 400 can be executed by the controller module 22.

The method 400 begins at step 404, and then moves to a step 408, which assesses whether a destination and range need is known. If yes, the method 400 moves to a step 412, which assesses whether there is a need to charge the traction battery 12 before reaching the destination.

If there is a need to charge before reaching the destination, the method 400 moves to a step 416, which assesses whether or not the electrified vehicle 10 is in traffic. If yes, the method 400 moves to a step 420 which, among other things, evaluates whether it saves total trip time to charge the traction battery 12 to avoid a traffic delay.

From the step 420, the method 400 moves to a step 424 which displays at least one charging location to a user, and prompts the user to make a selection from among the at least one charging stations or to cancel the display. From the step 424, the method 400 moves to a step 428 where the user can select a charging stop from the listing of at least one charging stops. The method 400 can then move to a step 432, which calculates a route to the selected charging stop and presents the route to the user. The method 400 then moves from a step 432 to the stop step 436.

At the step 428, the user can also cancel the method 428 at the step 324 and move directly to the stop step 436.

At the step 428, the user can also request additional information about the at least one charging stop from the step 424. The additional information can be displayed at a step 440. The additional information can include the location of the charging stops, distance to the charging stops, available charge levels at the charging stops, costs, etc. Amenities, such as food availability, restrooms, etc. that are associated with the charging stops can also be displayed at the step 440.

Next, at a step 444, the user can approve the charging stop having information displayed in the step 440. If approved, the method 400 moves from the step 444 to the step 432. If not approved, the method 400 can move to a step 448, which displays a list of amenities with, for example, checkboxes identifying which amenities are present at the at least one charging stop. At a step 452, the user can utilize the checkboxes or another input mechanism to identify which amenities are desired for the at least one charging stop. The method 400 then moves to a step 456 where the user can command the method 400 to search again for at least one stop based on the identified amenities from the step 452.

If the user commands the method 400 to search again, the method 400 moves from the step 456 back to the step 416. If the user commands the method 400 not to search again, the method 400 moves to the step 444.

Referring again to the step 416, if the method 400 determines that the electrified vehicle 10 is not in traffic, the method 400 moves to a step 460, which assesses whether or not traffic is building ahead of the electrified vehicle 10 along a route to the destination. If yes, the method 400 moves to the step 420. If not, the method 400 moves to a step 464, which assesses whether or not the user will driving at a mealtime. If yes, the method 400 moves to a step 468, which assesses charging stops that are available and, among other things, have food. From the step 468, the method 400 moves to the step 424.

If, at the step 464, the electrified vehicle 10 will not be driven through a mealtime, the method 400 moves to a step 472, which assesses whether the user will want to stop traveling to the destination to rest for the night, for example, even though the stop is not in the itinerary. If yes, the method 400 moves to a step 476, which investigates lodging locations along the route to the destination that also provide charging, among other things. From the step 476, the method 400 moves to the step 424. If, at the step 472, a stop for rest is unlikely, the method 400 moves from the step 472 to the stop step 436.

Referring again to the step 408, if the destination and range needs of the electrified vehicle 10 are not known, the method 400 moves to a step 480, which assesses whether or not the user will likely be going home or visit another potential charging location. If yes, the method 400 moves from the step 480 to the step 412. If not, the method 400 moves from the step 480 to stop step 436.

In an example of the method 400, a low state of charge of the traction battery 12 could trigger the method 400 to provide a recommended stop along with environmental factors, such a nighttime approaching, and traffic jams.

The recommended stop could account for the environmental factors, a time required to drive to the destination, an amount of charge required to reach the destination, a rate of charge provided by potential charging stops, a cost of the charge at potential charging stops, an availability of charging at potential charging stop. The method 400 then provides the user with one or more recommended stops that offer the least expensive and fastest charge capabilities. The recommended stops could be further refined by the user needs, such as a desire for food, restroom break, Wi-Fi hotspot etc.

If, for example, the traction battery 12 requires an additionally thirty percent charge to reach a destination, there is a traffic jam ahead along the route, and the user desires to purchase groceries, the method 400 could recommend that the user stop the electrified vehicle 10 at a grocery store having a charging station. This allows the user to shop for groceries and charge while the traffic jam is given time to clear. In such an example, the low state of charge and the traffic jam are the primary need or trigger, and the need for groceries is a secondary need that refines the grouping of stops meeting the primary need.

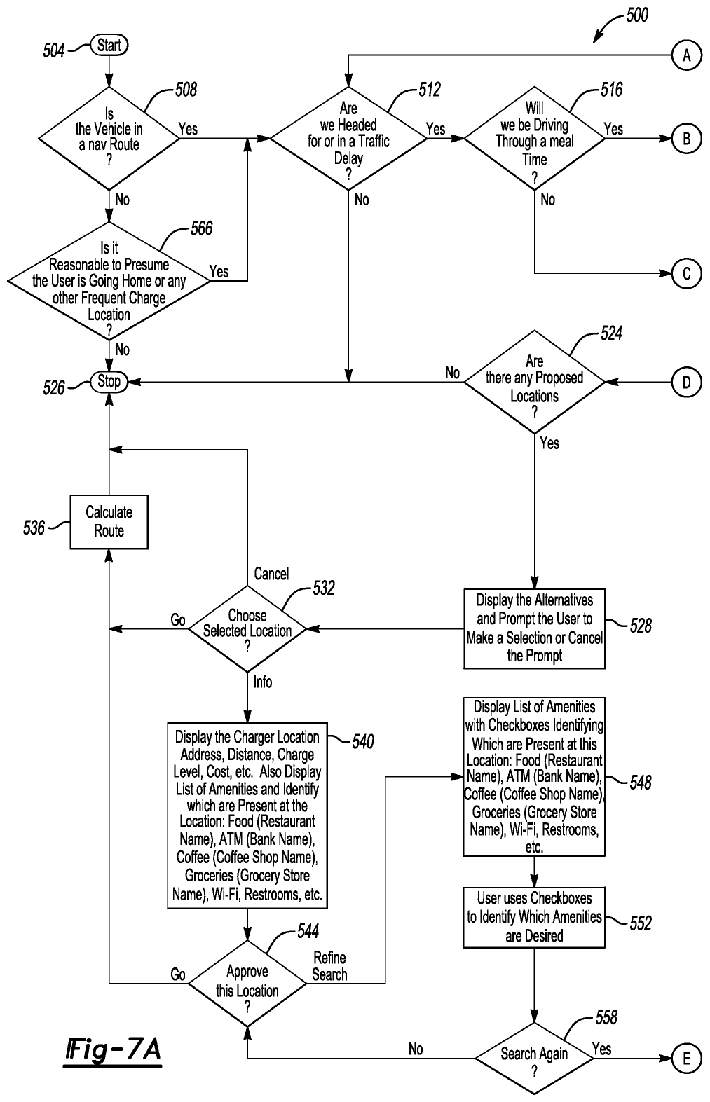

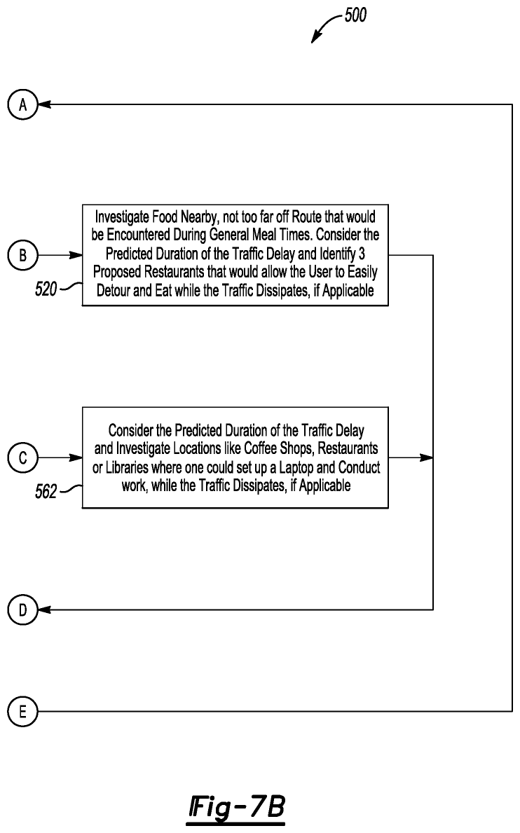

With reference now to FIGS. 7A-7B and continuing reference to FIG. 2, another example trip planning method 500 can assist a user of the electrified vehicle 10 during a drive along a route to a destination, or prior to beginning to travel along the route to the destination. At least some steps of the method 500 can be executed by the controller module 22.

The method 500 begins at a step 504. From the step 504, the method 500 moves to a step 508, which assesses whether the electrified vehicle 10 is in a navigated route. If yes, the method 500 moves to a step 512, which assesses whether the electrified vehicle 10 is headed into a traffic delay or whether the electrified vehicle 10 is in a traffic delay. If yes, the method 500 moves to a step 516, which assesses whether the electrified vehicle 10 will be driven through a mealtime. If yes, the method 500 moves to a step 520, which assesses nearby food locations.

The assessment in the step 520 can be based on the predicted duration of the traffic delay to identify proposed food locations, such as restaurants, that would allow a user of the electrified vehicle 10 to detour from their current route and eat while the traffic delay clears.

From the step 520, the method 500 moves to a step 524, which assesses whether the investigation in the step 520 revealed any potential stops. If no, the method 500 moves to a stop step 526. If yes, the stops are displayed to the user at a step 528 and the user is prompted to make a selection or to cancel the display.

From the step 528, the method 500 moves to a step 532 where the user can select a stop from the listing of at least one stops. If the user selects one of the stops in the step 532, the method 500 can then move to a step 536, which calculates a route to the selected stop and presents the route to the user. The method 500 then moves from the step 536 to the stop step 526.

At the step 532, the user can also cancel the method 500 and move directly to the stop step 526.

At the step 532, the user can also request additional information about the at least one stop from the step 528. The additional information can be displayed at a step 540. The additional information can include the location of the stops, distance to the stops. If the stop is a charging stop, the additional information can include available charge levels at the charging stops, costs, etc. Amenities, such as food availability, restrooms, etc. that are associated with the charging stops can also be displayed at the step 540.

Next, at a step 544, the user can approve the charging stop having information displayed in the step 540. If approved, the method 500 moves from the step 544 to the step 536. If not approved, the method 500 can move to a step 548, which displays a list of amenities with, for example, checkboxes identifying which amenities are present at the at least one stop. At a step 552, the user can utilize the checkboxes or another input mechanism to identify which amenities are desired for the at least one stop. The method 500 then moves to a step 558 where the user can command the method 500 to search again for at least one stop based on the identified amenities from the step 552.

If the user commands the method 500 to search again, the method 500 moves from the step 558 back to the step 512. If the user commands the method 500 not to search again, the method 500 moves to the step 544.

Referring again to the step 516, if the user will not be driving through mealtime, the method 500 instead moves to a step 562, which considers a predicted duration of the traffic delay and investigates locations like coffee shops, restaurants, or libraries where the user could set up a laptop and, for example, work while the traffic dissipates. From the step 562, the method 500 moves to the step 524.

Referring again to the step 512, if the electrified vehicle 10 is not in, or headed for, a traffic delay at the step 512, the method 500 moves to the stop step 526.

At the step 508, if the electrified vehicle 10 is not in a navigated route, the method 500 can assess, at a step 566, whether it is reasonable to presume that the user is going home or to another frequently visited location, such as a frequently visited charge location. If a destination can be reasonably presumed, the method 500 considers the presumed destination to be the destination and moves to the step 512. If a destination cannot be reasonably presumed, the method 500 moves from the step 566 to the stop step 526.

In an example of the method 500, an approaching meal time or nighttime, and an upcoming traffic jam could trigger the method 500 to provide a recommended stop. In such an example, the electrified vehicle 10 does not require additional charging to reach the destination, but may need charge for a future trip.

The recommended stop could account for a time required to drive to the destination, an amount of charge required to reach the destination, a rate of charge provided by potential charging stops, a cost of the charge at potential charging stops, an availability of charging at potential charging stop. The method 500 then provides the user with one or more recommended stops that offer the least expensive and fastest charge capabilities. The recommended stops could be further refined by the user needs, environmental factor, or both. For example, the method 500 could recommend the user stops at a restaurant to eat and the charge the traction battery 12. The recommended stop will give the traffic jam time to clear, and allow the user to top off the traction battery 12 for a future trip.

In such an example, the approach of meal time and the upcoming traffic jam are the primary needs or triggers, and the need to charge is a secondary need that refines the grouping of stops meeting the primary need. While the charging is not immediately required, the method 500 facilitates a more productive use of the user's time.

In another example of the method 500, the electrified vehicle 10 has enough charge to reach a destination, say a campsite where the user will spend the night and where no charging is available. However, some charging of the traction battery 12 will be required for driving the electrified vehicle 10 on a future trip, say a trip departing from the campsite the next day. Also, a time of day is approaching a mealtime. In response to these triggers, the method 500 provides the user with at least one recommended stop based on the approaching mealtime and a need to charge the traction battery 14 before a drive tomorrow. The method 500 could, for example, recommend that the user stops the electrified vehicle 10 at a restaurant with a charging station. At the restaurant, the user can eat and “top off” the traction battery 14.

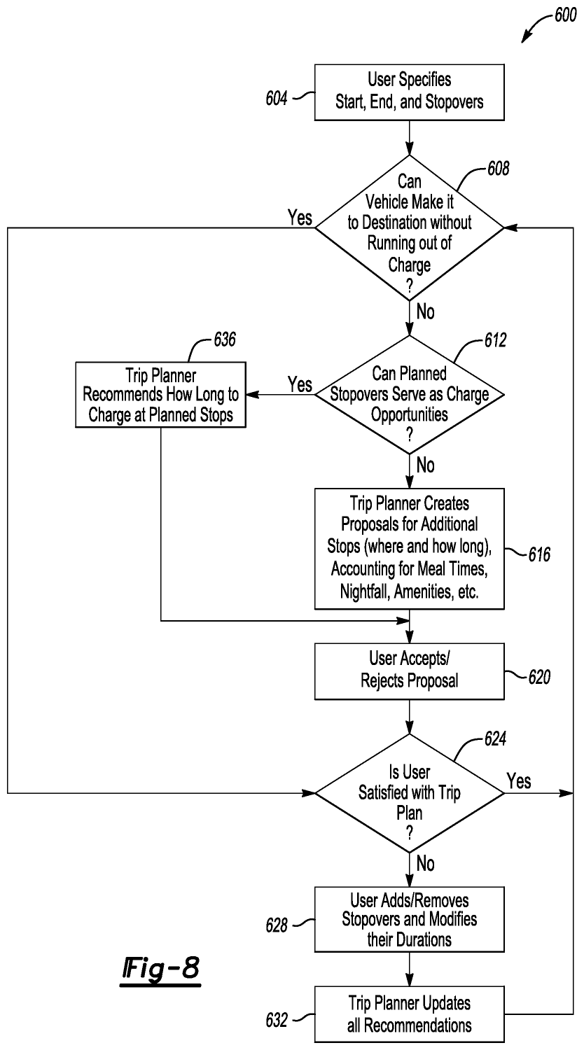

With reference now to FIG. 8 and continuing reference to FIG. 2, another example trip planning method 600 can assist a user of the electrified vehicle 10 prior to beginning to travel along a route to a destination, or while traveling along the route to the destination. At least some steps of the method 600 can be executed within a trip planner portion of the controller module 22.

At a step 604, a user can specify a start location, a destination where the trip will end, and stopovers along the route to the destination. From the step 604, the method 600 moves to a step 608, which assesses whether or not the user will make it to the destination without running out of charge of the traction battery 12.

If the user cannot make it to the destination without running out of charge, the method 600 moves from the step 608 to a step 612, which assesses whether the planned stopovers can serve as charge opportunities. If not, the method 600 moves to a step 616 where the trip planner of the electrified vehicle 10 creates proposals for additional stops accounting for variables such as mealtimes, nightfall, amenities available at the potential charging stops, etc.

From the step 616, the method 600 moves to a step 620, which proposes at least one charge location to the electrified vehicle 10. At the step 620, the user can accept or reject the proposed charge location and indicate whether the user is satisfied with the revised trip plan at a step 624. If the user is satisfied with the trip plan at the step 624, the method 600 returns to the step 608. If the user is not satisfied with the trip plan at the step 624, the method 600 moves to a step 628, which enables the user to add/remove stopovers and modify their durations.

Next, at a step 632, the trip planner of the electrified vehicle 10 updates the recommendations and moves back to the step 608.

Referring again to the step 612, if the planned stopovers can serve as charge opportunities, the method 600 moves to a step 636 where the method 600 recommends how long to charge at the planned stops. From the step 636, the method 600 moves to the step 620.

Referring again to the step 608, if the vehicle can make it to the destination without running out of charge, the method 600 moves from the step 608 to the step 624.

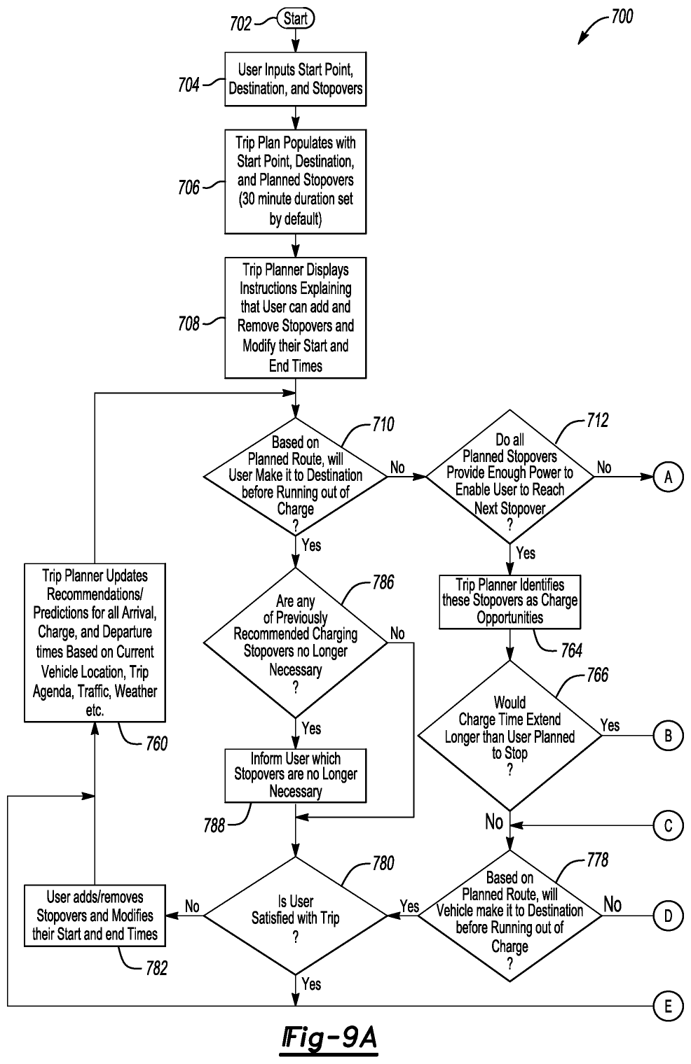

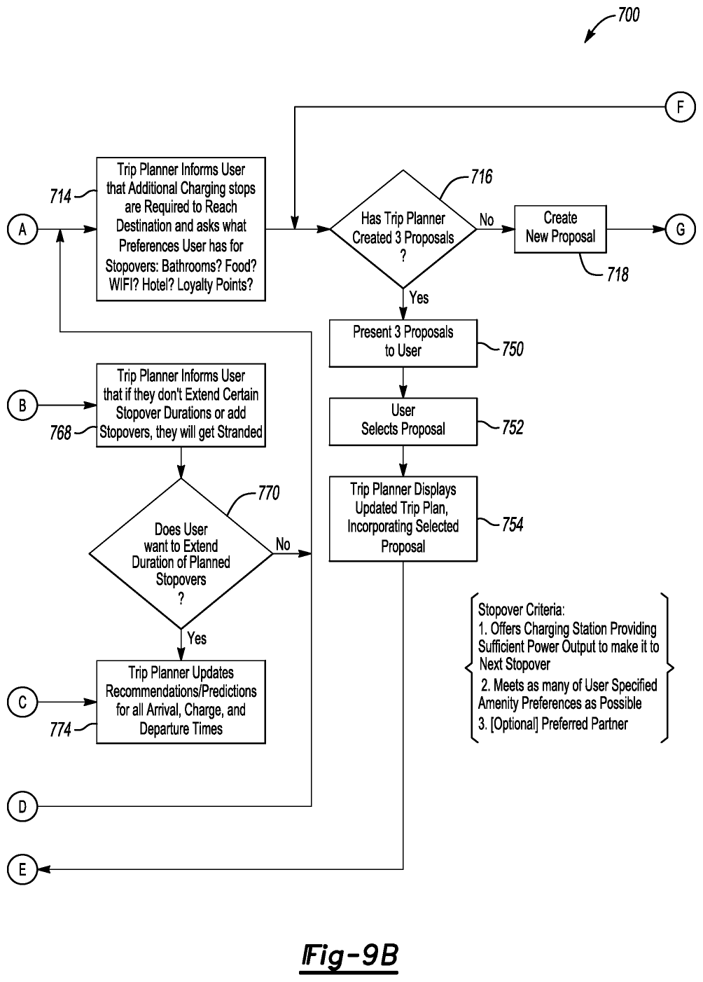

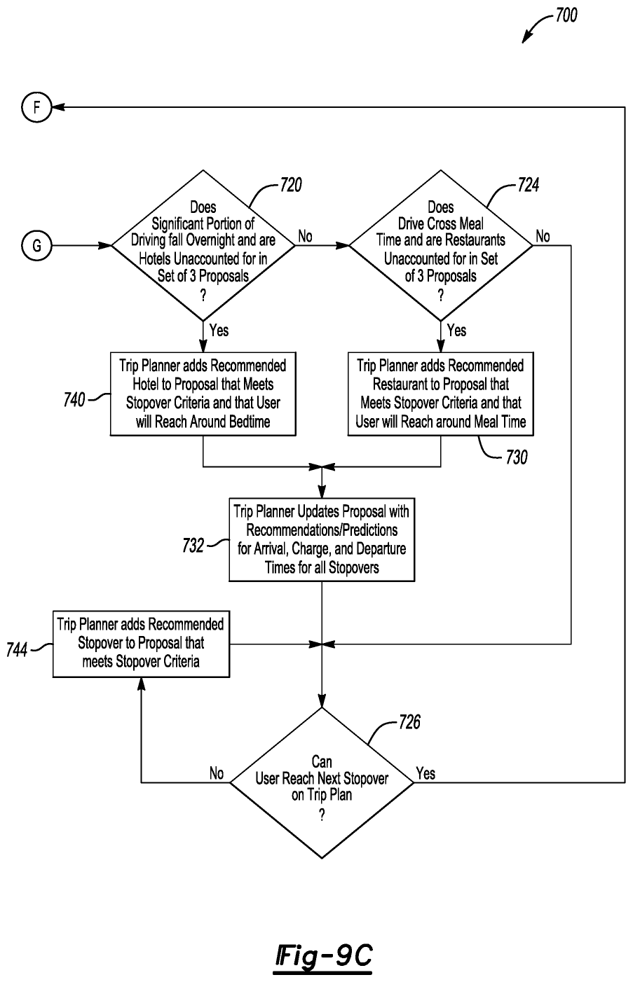

With reference now to FIGS. 9A-9C and continuing reference to FIG. 2, another example trip planning method 700 can assist a user of the electrified vehicle 10 prior to beginning to travel along a route to a destination or while traveling along the route to the destination. At least some steps of the method 700 can be executed by the controller module 22, and specifically a trip planner portion of the controller module 22.

The method 700 begins at a start step 702 and then moves to a step 704 where a user inputs a trip plan including, for example, a start point, a destination, and stopovers. The user can create the trip plan via an in-vehicle user interface or outside the electrified vehicle 10 via a mobile or web app/interface. Next, at a step 706, the method 700 populates a trip plan with the start point, the destination, and stopovers. A 30 minute duration at the stopovers can be set by the trip planner by default. The durations could be adjustable by the user.

Next, at a step 708, the trip planner of the controller module 22 displays instructions to the user explaining that the user can add or remove stopovers and modify their start and end times.

Next, at a step 710, the method 700 assesses, based on the planned route, whether the user will make it to the destination before the electrified vehicle 10 runs out of charge. If not, the method 700 moves from the step 710 to a step 712, which assesses whether all of the planned stopovers provide enough power to enable the user to reach the next stopover.

If not, the method 700 moves to the step 714 where the trip planner informs the user that additional charging stops are required to reach the destination and asks what preferences the user has for these stopovers. Exemplary preferences could include does the stopover have bathrooms, food, Wi-Fi, a hotel, loyalty points.

From the step 714, the method 700 moves to a step 716, which assesses whether the trip planner of the controller module 22 has created three proposals. If not, the method 700 moves to a step 718, which creates a new proposal.

The method 700 the moves to a step 720, which assesses whether a significant portion of driving to the destination will be overnight and whether any hotels are unaccounted for in the set of proposals. If not, the method 700 moves to the step 724, which assesses whether the drive to the destination will run across mealtimes, and whether restaurants are unaccounted for in the set of three proposals. If not, the method 700 moves to a step 726, which assesses whether the electrified vehicle 10 can reach the next stopover on the trip plan. If yes, the method 700 moves from the step 726 back to the step 716.

If, at the step 724, the drive along the route will cross mealtimes and restaurants are unaccounted for, the method 700 moves to the step 730 where the trip planner adds recommended restaurants, for example, to the trip proposal. The recommended restaurants meet stopover criteria and are restaurants that the electrified vehicle will pass by around mealtime.

The method 700 then moves to step 732 where the trip planner updates the proposal with recommendations/predictions for arrival, charge, and departure times for all stopovers. The method 700 then moves to the step 726.

At the step 720, if a significant portion of the driving time to the destination will be overnight and hotels are unaccounted for, the method moves to the step 740 where the trip planner adds recommended hotels, for example, to the proposal that meet the stopover criteria and that the user will reach around bedtime or nightfall. From the step 740, the method 700 moves to the step 732, and then to the step 726.

At the step 726, if the user will not reach the next stopover on the trip plan, the method 700 moves to the step 744 where the trip planner adds recommended stopovers to the proposal that meet the stopover criteria. The method 700 then moves back to the step 726.

Referring back to the step 716, if the trip planner has created three proposals, the method 700 moves to the step 750, which presents these three proposals to the user, and then to a step 752 where a user selects one of the proposals. Next, at a step 754, the trip planner displays upgraded trip plans incorporating the selected proposal.

The method 700 then moves to a step 760 where the trip planner updates the recommendations/predictions for all arrivals/charge and departure times based on current electrified vehicle location, trip agenda, traffic, weather, etc. The method 700 moves from the step 760 back to the step 710.

Referring back to the step 712, if all of the planned stopovers provide enough power to enable the electrified vehicle 10 to reach the next stopover, the method 700 moves to the step 764, where the trip planner identifies the stopovers as charge opportunities. The method 700 then moves to the step 766 where the method 700 assesses whether the charge opportunities would require the user to charge the electrified vehicle 10 for longer duration than what had been planned for the stop.

If yes, the trip planner, at a step 768, informs the user that if they do not extend certain stopover durations or add stopovers, they will be stranded.

Next, at a step 770, the method 700 assesses whether the user wants to extend the duration of the planned stopovers. If no, the method 700 returns to the step 714. If yes, the method 700 moves to the step 774 where the trip planner updates recommendations/predictions for all arrivals, charge, and departure times.

From the step 774, the method 700 moves to a step 778, which, based on the planned route, assesses whether the electrified vehicle 10 will make it to the destination before running out of charge. If yes, the method 700 requests that whether or not the user is satisfied with the trip at the step 780. If not, the method 700 moves to a step 782 where the user can add or remove stopovers and modify the start and end times.

From the step 782, the method 700 moves to the step 760. If the user is satisfied with the trip at the step 780, the method 700 moves directly to the step 760.

If, at the step 766, utilizing the charge opportunities would not require the user to charge for a longer duration that what they had planned for the stop, the method 700 moves from the step 766 directly to the step 778.

Referring back to the step 710, if the electrified vehicle 10 will make it to the destination before running out of charge, the method 700 moves to the step 786, which assesses whether any of the previously recommended charging stopovers are no longer necessary or feasible. If not, the method 700 moves from the step 786 directly to the step 780. If yes, the method 700 moves from the step 786 to a step 788, which informs the user which stopovers are no longer necessary. The method 700 then moves from the step 788 to the step 780.

Features of the disclosed examples can include, among other things, providing a user with intelligent recommendations for stops along a route to a destination. The decision can take into account various parameters, such as remaining range of an electrified vehicle, distance to the stops, the current route to the destination, etc. The recommendations can be part of a trip planner feature of the vehicle.

The trip planner feature can make “smart” recommendations to the user in real time for, if applicable, charging stops that take into account user needs, vehicle needs, and environmental factors, or some combination of these.

The smart recommendations could, in some examples, additionally take into account one or more of an identity of the user, wait times at restaurants along a route, other occupants in the vehicle (e.g., children, pets), travel plans of the other occupants, and medical conditions (e.g., stops for snacks to adjust blood sugar of the user and any other occupants. The smart recommendations could pull the travel plan information by linking to digital calendars associated with the other occupants.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A trip planning method, comprising:
recommending at least one stop for a vehicle,
under first conditions, the recommending is based on a vehicle need and a user need,
under second conditions, the recommending is based on the vehicle need and an environmental factor.

2. The trip planning method of claim 1, wherein the recommending occurs prior to departing on a drive to a destination.

3. The trip planning method of claim 1, wherein the vehicle need is a charge of a traction battery, and the at least one stop includes a plurality of charging stops presented to a user of the vehicle.

4. The trip planning method of claim 3, wherein the plurality of charging stops includes a charging stop designated as a least expensive charging stop and a charging stop designated as a fastest charging stop.

5. The trip planning method of claim 1, wherein the recommending includes recommending a stop based on the stop having a 110 Volt power outlet.

6. The trip planning method of claim 1, wherein the vehicle need is a charge of a traction battery and the at least one stop is at least one charging stop, and further comprising providing an alert to a user based on a distance to the at least one charging stop and a distance to empty for the vehicle.

7. The trip planning method of claim 6, further comprising varying the alert based on the distance to the at least one charging stop and the distance to empty for the vehicle.

8. The trip planning method of claim 7, wherein the alert is a text based message.

9. The trip planning method of claim 6, wherein the recommending is after the providing of the alert.

10. The trip planning method of claim 6, further comprising receiving a selected charging stop selected by the user, and updating a route for the vehicle based on the selected charging stop.

11. The trip planning method of claim 1, wherein the user need, the vehicle need, and the environmental factor are each categorized as low urgency or high urgency.

12. The trip planning method of claim 11, wherein the recommending prioritizes a high urgency vehicle need above both low and high urgency user needs.

13. The trip planning method of claim 1, wherein the environmental factor includes at least one of a traffic condition or a weather condition.

14. A trip planning assembly, comprising:
a controller module that recommends at least one stop for a vehicle,
under first conditions, the at least one stop is recommended based on a vehicle need and a user need,
under second conditions, the at least one stop is recommended based on the vehicle need and an environmental factor.

15. The trip planning assembly of claim 14, wherein the vehicle includes the controller module.

16. The trip planning assembly of claim 14, further comprising a traction battery of the vehicle, wherein the vehicle need is a charge of the traction battery.

17. The trip planning assembly of claim 16, wherein the at least one stop includes a plurality of charging stops presented to a user of the vehicle.

18. The trip planning assembly of claim 17, further comprising a display within the vehicle, the plurality of charging stops presented to the user on the display.

19. The trip planning assembly of claim 14, wherein the vehicle need is a charge of a traction battery and the at least one stop is at least one charging stop, the controller module providing an alert to a user based on a distance to the at least one charging stop and a distance to empty for the vehicle.
